(19) United States
(12) Patent Application Publication
(10) Pub. No.: US 2022/0261523 A1
(43) Pub. Date: Aug. 18, 2022

(54) BEHAVIORAL-LEVEL TIMING AND AREA OPTIMIATION

(71) Applicant: Xilinx, Inc., San Jose, CA (US)

(72) Inventors: FAN ZHANG, San Jose, CA (US); CHAITHANYA DUDHA, San Jose, CA (US); NITHIN KUMAR GUGGILLA, Hyderabad (IN); KRISHNA GARLAPATI, Los Gatos, CA (US)

(73) Assignee: Xilinx, Inc., San Jose, CA (US)

(21) Appl. No.: 17/177,778

(22) Filed: Feb. 17, 2021

(51) Int. Cl. G06F 30/337; G06F 30/31; G06F 30/327

(52) U.S. Cl. CPC G06F 30/337; G06F 2119/12; G06F 30/327; G06F 30/31

(57) ABSTRACT

Disclosed methods and systems involve, prior to mapping logic of the module to a target integrated circuit (IC) technology, estimating total delay of a module of a circuit design and determining whether or not the module is timing critical based on the total delay of the module and a timing constraint. Also prior to mapping, the module is restructured for timing optimization in response to determining that the module is timing critical. In response to determining that the module is not timing critical, and prior to mapping, the module is restructured for area optimization. The elements of the module are then mapped to the circuit elements of the target IC technology, followed by place-and-route and generating implementation data for making an IC that implements the circuit design.

### TECHNICAL FIELD

The disclosure generally relates to selectively optimizing circuit designs for timing or area.

### BACKGROUND

Timing closure is one example of an important objective for Electronic Design Automation (EDA) tools in processing circuit designs targeted to application specific integrated circuit (ASICs), system on chips (SoCs), or field programmable gate arrays (FPGAs). Area optimization is another important objective. Oftentimes, achieving timing closure can negatively impact area optimization, and optimizing for area can degrade timing. The complexity involved in achieving timing closure and area optimization often forces designers to perform multiple iterations through the EDA tool flow to achieve closure on a design. Changes to the circuit design are often required between iterations.

### SUMMARY

A disclosed method includes estimating total delay of a module of a circuit design by an electronic design automation (EDA) tool prior to mapping logic of the module to a target integrated circuit (IC) technology. The EDA tool determines, prior to mapping, whether or not the module is timing critical based on the total delay of the module and a timing constraint. The method includes the EDA tool restructuring the module for timing optimization prior to mapping elements of the module to circuit elements of the target IC technology, in response to determining that the module is timing critical. The method includes restructuring the module for area optimization by the EDA tool prior to the mapping, in response to determining that the module is not timing critical. The method includes mapping the elements of the module of the circuit design to the circuit elements of the target IC technology, and placing and routing the circuit elements by the EDA tool, and the EDA tool generating implementation data after the mapping, placing, and routing for making an IC that implements the circuit design.

A disclosed system includes one or more processors and a memory arrangement configured with instructions that when executed by the one or more processors cause the one or more processors to implement an electronic design automation (EDA) tool. The EDA tool performs operations including estimating total delay of a module of a circuit design prior to mapping logic of the module to a target integrated circuit (IC) technology. The operations include determining prior to mapping, whether or not the module is timing critical based on the total delay of the module and a timing constraint. The operations include restructuring the module for timing optimization prior to mapping elements of the module to circuit elements of the target IC technology, in response to determining that the module is timing critical. The operations include restructuring the module for area optimization prior to the mapping, in response to determining that the module is not timing critical. The EDA tool performs additional operations including mapping the elements of the module of the circuit design to the circuit elements of the target IC technology, and placing and routing the circuit elements. The operations also include generating implementation data after the mapping, placing, and routing for making an IC that implements the circuit design.

Other features will be recognized from consideration of the Detailed Description and Claims, which follow.

### BRIEF DESCRIPTION OF THE DRAWINGS

Various aspects and features of the method and system will become apparent upon review of the following detailed description and upon reference to the drawings in which:

FIG. 1 is a flowchart of an exemplary process of using timing budgeting on modules of a circuit design to select modules for either timing or area optimization prior to mapping to a target integrated circuit (IC) technology;

FIG. 2 shows an example of a circuit design and the hierarchical relationship of the modules of the design;

FIG. 3 shows an example of a dataflow graph corresponding to the circuit design of FIG. 2;

FIG. 4 shows a flowchart of a process for determining the timing criticality of a module;

FIG. 5 shows an example of a circuit in which an operator is shared for area optimization;

FIG. 6 shows a circuit that is functionally equivalent to the circuit of FIG. 5 in which the operator is unshared for timing optimization;

FIG. 7 shows an example of a priority multiplexing circuit optimized for area;

FIG. 8 shows a circuit that is functionally equivalent to the circuit of FIG. 7 optimized for timing;

FIG. 9 shows an example of a counter optimized for area;

FIG. 10 shows an alternative counter optimized for timing; and

FIG. 11 is a block diagram illustrating an exemplary data processing system.

### DETAILED DESCRIPTION

In the following description, numerous specific details are set forth to describe specific examples presented herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element.

EDA tools perform timing and area optimization in processing a circuit design. Generally, timing can be improved at the expense of additional area, or the area of a circuit design can be reduced at the expense of timing. For example, additional circuit resources may be added to a circuit design in restructuring circuits to meet timing constraints. However, added circuit elements may increase the area of a die needed to implement the circuit design. In other cases, a particular function of a circuit design may be implemented with fewer circuit elements than initially specified in order to reduce the footprint. However, restructuring the circuit may degrade the timing.

In attempting to satisfy both timing and area constraints, an EDA tool may perform numerous iterations, and each iteration can consume considerable computational resources. Furthermore, a resulting placed-and-routed circuit design, though satisfactory, may be suboptimal when compared to a result that could have otherwise been achieved by taking a more informed approach.

According to the disclosed approaches, timing budgeting is performed at the module level, and each module is tagged for either timing or area optimization based on the timing budgeting. Using timing budgeting early in the design flow to select either timing or area optimization can yield significant improvements in the tradeoff between timing and area in the overall circuit design. Deciding whether a module should be optimized for timing or area at an early stage in the design flow (prior to mapping) can have a large impact on the quality of results of the finally placed-and-routed circuit design. A drawback to current approaches is that the entire circuit design is optimized for timing or area early in the design flow, and the early optimizations can introduce changes that cannot easily be adjusted later in the design flow should adjustments be needed to satisfy timing or area constraints. The disclosed approaches improve the timing and area comprises made in producing a finally placed-and-routed circuit design, and can also decrease the computing resources required to achieve desired results by avoiding numerous iterations to achieve desired results.

In an exemplary approach, an EDA tool uses timing budgeting early in the design flow to selectively optimize modules either for timing or area. The tool estimates a total delay of a module of a circuit design prior to mapping logic of the module to a target integrated circuit (IC) technology. Prior to mapping, the tool determines the criticality of timing to the module based on the total delay of the module and a timing constraint. The tool restructures the module for timing optimization prior to mapping in response to determining that the module is timing critical, or restructures the module for area optimization prior to the mapping in response to determining that the module is not timing critical. A module is timing critical if the logic suggests that adjustments may be needed to satisfy timing constraints. After the early stage optimizations, the tool maps the circuit design to circuit elements of the target IC technology, and places and routes the circuit elements. After place-and-route, the tool generates implementation data for making an IC that implements the circuit design.

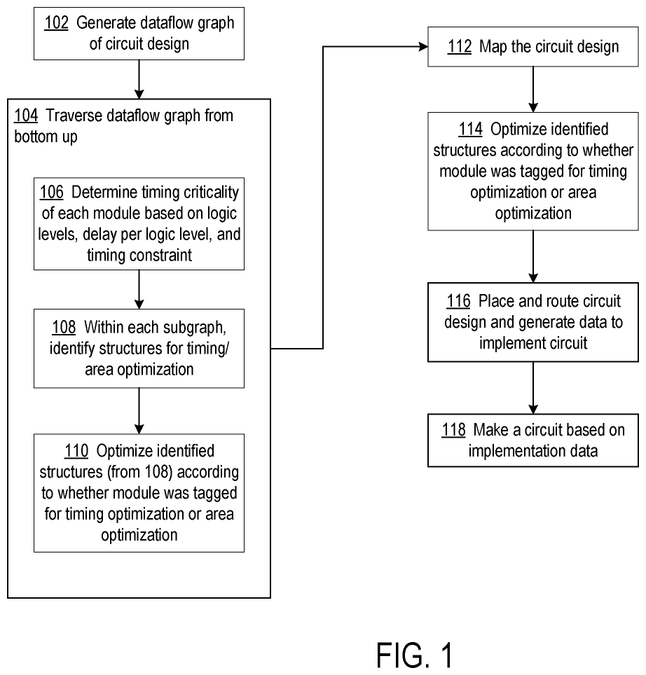

FIG. 1 is a flowchart of an exemplary process of using timing budgeting on modules of a circuit design to select modules for either timing or area optimization prior to mapping to a target integrated circuit (IC) technology. At block 102, an EDA tool generates a dataflow graph from an input circuit design. The input from which the dataflow graph is generated can be a register transfer level (RTL) specification, which in turn was generated from a higher level specification, such as VHDL or a high-level programming language (e.g., C or C++).

The processing of block 104 is performed by the EDA tool in applying timing budgeting to modules of the circuit design prior to mapping the circuit design. The EDA tool traverses the dataflow graph from the lowest level to the highest level and performs the processing of blocks 106, 108, and 110 on each module.

The dataflow graph has subgraphs corresponding to RTL modules. Within each subgraph, the EDA tool perform pattern matching to identify sub-structures that are of interest for timing/area optimization. In an example of pattern matching involving a counter circuit, the EDA tool searches for register bank nodes in the subgraph, and then backward traverses from one of the register bank nodes to find an incrementer node. From the incrementer node, the EDA tool determines the input edge from the register bank node. If the feedback loop involving the register bank node and incrementer node was successfully identified and matched, additional optimization can be performed. Each node has information indicative of the type of circuit/functionality for purposes of pattern matching.

At block 106, the EDA tool determines whether or not the module is timing critical based on an estimated total delay of the module and a timing constraint imposed on the circuit design. The timing criticality indicates whether the module should be tagged for timing optimization or tagged for area optimization.

The estimated total delay of a module can be determined based on a fine-grain approach and/or a coarse grain approach. In the fine-grain approach, the EDA tool determines the number of logic levels in the module and a device/technology-specific timing budget per logic level. The timing budget per logic level is device/technology dependent and can be determined from a lookup table of device/technology identifiers and associated timing values. For a target device such as an FPGA, the timing budget can be time per level of lookup table. The fine-grain estimated delay is the product of the timing budget per logic level and the number of logic levels in the module.

In the coarse-grain approach, the EDA tool identifies particular logic in the dataflow graph for which the number of logic levels cannot be directly counted. For example, an adder can be identified in the dataflow graph, but the carry chains used to implement the full adder are not yet specified. The width of the adder can be used to estimate the number of carry chains, and a lookup table having stored values of previously estimated delays can be consulted to obtain the estimated delay of the adder. The total delay of the module can be the sum of delay obtained from the lookup table and the delay estimated from the fine-grain approach. Similar previously estimated can be looked-up for other data path operators, such as other arithmetic and logic operators and multiplexing.

If the total estimated delay of the module is greater than or equal to the timing constraint, the module can be tagged for timing optimization. Otherwise, the module can be tagged for area optimization. The specifications of circuit functions and structures created by the EDA tool can have associated attributes assigned by the EDA to indicate the tagging.

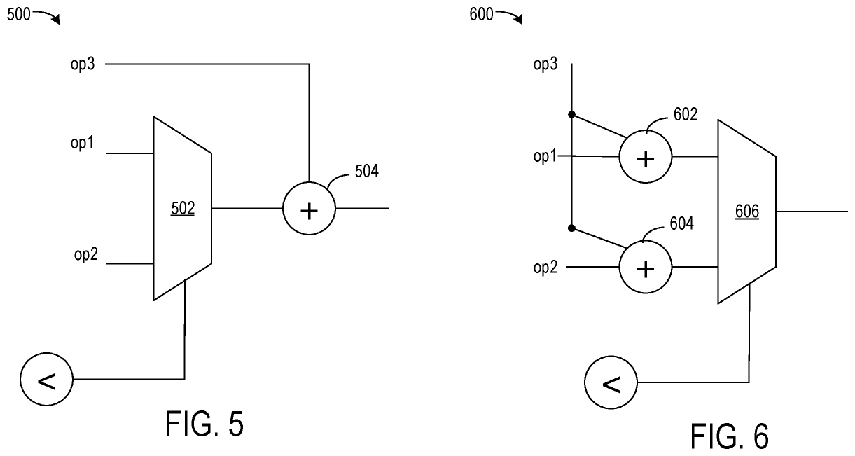

At block 108, the EDA tool identifies logic within each subgraph that can be optimized according to the timing criticality determined for the module. Examples of logic structures that are candidates for either timing or area optimization include operator sharing/unsharing, priority multiplexing, wide counters (e.g., FIGS. 5-10), packing multiple operators into a digital signal processor (DSP), and doubling the clock speed to save resources. The set of logic structures identified for optimization can evolve as designers gain experience.

If the module was tagged for timing optimization, the EDA tool at block 110 optimizes the structures identified at block for timing. Otherwise, if the module was tagged for area optimization, the EDA tool at block 110 optimizes the structures identified at block for area. The optimizations can involve restructuring the identified logic. Examples are provided in FIGS. 5-10.

The module-level optimizations made early in the design flow and specifically targeted to optimizing either timing or area can yield significant improvements in the quality of the finally placed-and-routed result.

At block 112, the EDA tool maps the circuit design to circuit elements of the target IC device/technology. Additional optimization of the circuit design can be performed by the EDA tool at block 114. The optimizations at block 114 can be specific to each module based on whether the module was tagged for timing optimization or tagged for area optimization. The attribute indicating whether a module is tagged for timing optimization or area optimization can be carried over from the dataflow graph to the mapped module netlist, because the dataflow graph can have sub-graphs corresponding to user RTL modules.

At block 116, the EDA tool places and routes the circuit design and generates implementation data. The implementation data can be used to make an operable IC device at block 118. The IC device can be an FPGA, ASIC, system-on-chip, system-in-package, etc.

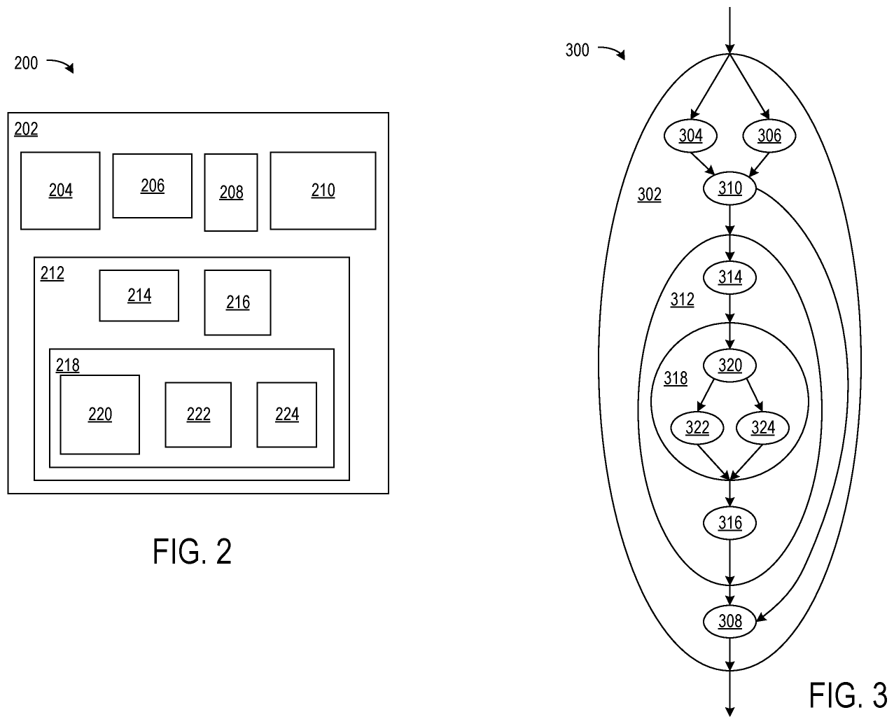

FIG. 2 shows an example of a circuit design 200 and the hierarchical relationship of the modules of the design. Module 202 is the top-most module of the design, and modules 204, 206, 208, 210, and 212 are contained within module 202 in the next level of the hierarchy. Modules 214, 216, and 216 are contained within module 212 in the next level of the hierarchy, and modules 220, 222, and 224 are contained within module 218 in the lowest level of the hierarchy.

FIG. 3 shows an example of a dataflow graph 300 corresponding to the circuit design 200 of FIG. 2. The dataflow graph has nodes and directed edges. Each node corresponds to one of the modules of the circuit design, and each edge indicates a dependency of one module on data generated by another module. It will be recognized that a data flow graph can include subgraphs that describe each of the nodes in more detail.

The graph has subgraphs that correspond to the hierarchical relationship between the modules of the circuit design 200. Node 302 corresponds to module 202, and nodes 304, 306, 308, 310, and 312 correspond to modules 204, 206, 208, 210, and 212, respectively. Nodes 314, 316, and 318 correspond to modules 214, 216, and 218, respectively; and nodes 320, 322, and 324 correspond to modules 220, 222, and 224, respectively.

Each module of circuit design 200 can be optimized for either timing or area depending on the timing criticality determined for the module. For example, modules 204, 208, 216, and 218 can be identified as timing critical from the corresponding nodes/subgraphs, and modules 206, 210, and 214 can be identified as being not timing critical. Logic structures within modules 204, 208, 216, and 218 can be optimized for timing, and logic structures within modules 206, 210, and 214 can be optimized for area.

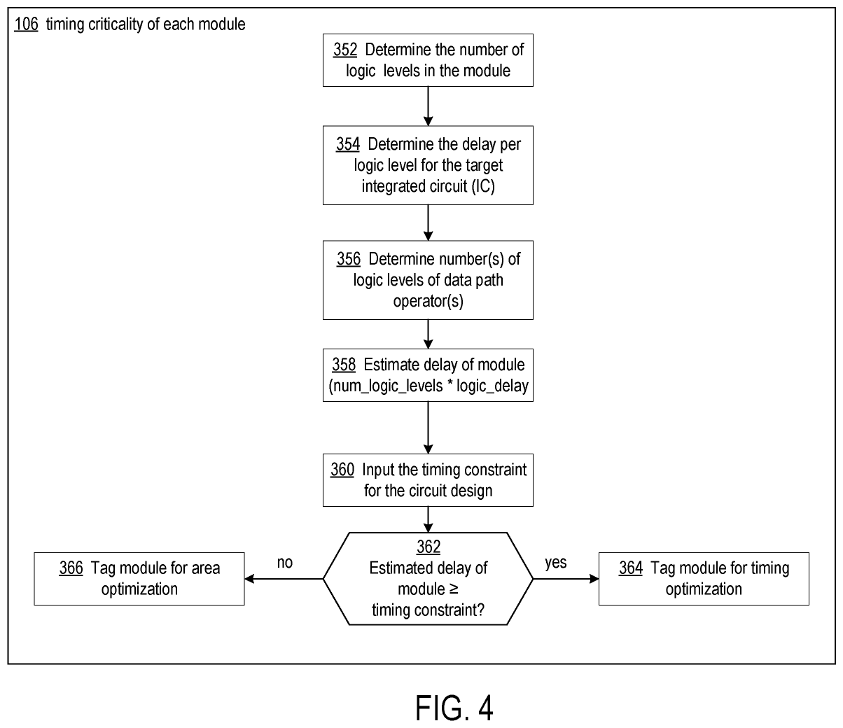

FIG. 4 shows a flowchart of a process for determining the timing criticality of a module. Generally, if a module is determined to be timing critical, that module is tagged for timing optimization. Otherwise, the module is tagged for area optimization.

At block 352, the EDA tool determines the number of logic levels in a module. Different types of nodes in the dataflow graph correspond to different circuitry. For example, a logic partition node can contain a partition of a combinatorial circuit having N inputs. Known heuristic algorithms can be used to estimate the number of LUT logic levels given the number of inputs to the combinatorial circuit. Additionally, known heuristic algorithms can be used to estimate the number of logic levels of more specific nodes, such as adders, comparators, or multiplexers. Each type of target IC device technology has a previously estimated of delay per logic level, and at block 354, the EDA tool looks up or otherwise inputs the delay per logic level of the target.

At block 356, the EDA tool can optionally coarsely estimate the number of logic levels of data path operators found in the module. As indicated above, the number of logic levels in data path operators such as + and > may not be directly obtained from the circuit specification. The number of logic levels of a data path operator can be estimated by determining the width of the data path from the specification and looking up a previously computed number of logic levels associated with the data path operator.

The total delay of the module is determined by the EDA tool at block 358. The total delay is a product of the delay per logic level and the total of the number of the logic levels determined at block 352 and 356.

The EDA tool inputs the timing constraint for the circuit design at block 360 and at decision block 362 determines whether or not the module is timing critical. If the estimated delay of the module is greater than or equal to the timing constraint, then the module is timing critical, and the EDA tool tags the module for timing optimization at block 364. Otherwise, the EDA tool tags module for area optimization at block 366. Tagging a module can include storing data in association with the specification of the various circuit elements of the module in the data flow graph.

As an example, consider a circuit design having modules A, B, and C and a timing constraint of 10 ns, and a target IC device/technology having a delay per logic level of 500 ps. If module A has 20 logic levels, module B has 5 logic levels, and module C has 5 logic levels, the estimated total delays of the modules are 10 ns, 2.5 ns, and 2.5 ns, respectively. Module A is timing critical and can be tagged for timing optimization, because the estimated delay of 10 ns is equal to the timing constraint of 10 ns. Modules B and C are not timing critical (2.5 ns <10 ns) and can be tagged for area optimization.

FIGS. 5-10 show examples of circuits that are optimized for area versus timing. FIG. 5 shows an example of a circuit 500 in which an operator is shared for area optimization, and FIG. 6 shows a circuit 600 that is functionally equivalent to the circuit of FIG. 5 in which the operator is unshared for timing optimization.

The logic of circuit 500 may appear in a data flow graph within a module. The addition operator is shared between adding op1 to op3 and adding op2 to op3. The less-than operator controls the multiplexer 502 for selecting op1 or op2. If the module is tagged for area optimization, the logic can remain as shown in FIG. 5. If the module is tagged for timing optimization, the logic can be restructured into the functionally equivalent circuit 600.

In restructuring the logic of FIG. 5, the EDA tool removes the instance 504 of the addition operator and creates two instances 602 and 604 of the addition operator in the restructured circuit 600. The instances 602 and 604 of the addition operator are connected to input the operands op1 and op2, respectively, and connected to input the operator op3. The output from the instances of the addition operator are connected to the inputs of the multiplexer 606.

For an exemplary target IC technology that is an FPGA, the circuit of the logic in FIG. 5 can involve back-to-back carry chains to implement the less-than operator and the addition operator in the path. The circuit of the logic in FIG. 6 has only one carry chain from any input to any output but includes an additional addition operator and occupies a greater area.

The logic of circuit 600 can be optimized for area if the logic of circuit 600 appears in a data flow graph within a module, and the module is tagged for area optimization. The optimization would entail restructuring the logic of FIG. 6 to remove the instances of the addition operators 602 and 604 and the input of op3, and creating an instance 504 of the addition operator that has inputs connected the output of the multiplexer 502 and op3.

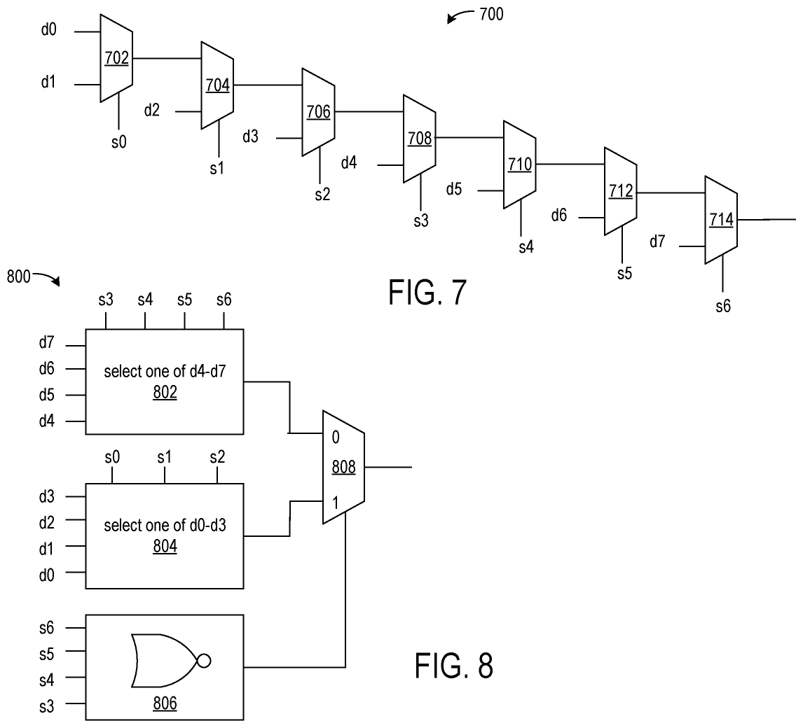

FIG. 7 shows an example of a priority multiplexing circuit optimized for area, and FIG. 8 shows a functionally equivalent priority multiplexing circuit 800 optimized for timing. As is generally, known, priority multiplexing involves the selection of one of M data signals based on the assertion of one of M-1 select signals, assuming that one and only one of the select signals is asserted.

The logic of circuit 700 may appear in a data flow graph within a module. The priority multiplexing logic can have multiple alternative inputs (e.g., d0-d7) and multiple selector inputs (e.g., s0-s6) that control selection of one (and only one) of the inputs by multiplexers 702, 704, 706, 708, 710, 712, and 714. If the module is tagged for timing optimization, the logic can be restructured by specifying two or more units of selection logic such as selection logic 802 and 804 in FIG. 8. The units of selection are configured to operate in parallel. A first unit of selection logic 802 specifies selection of one input of a first subset of the alternative inputs (d4-d7) in response to a first subset (s3-s6) of the selector inputs. A second unit of selection logic 804 specifies selection of one input of a second subset of the alternative inputs (d0-d3) in response to a second subset of the plurality of selector inputs (s0-s2). Additional units of selection logic can be constructed if required to handle additional subsets of alternative inputs. A final unit of selection logic 806 controls selection of one output from the other units of selection logic by the multiplexer 808 in response to a third subset of the plurality of selector inputs (s3-s6).

For an exemplary target IC technology that is an FPGA, the circuit of the logic in FIG. 7 requires only 4 LUTs but has a longer path delay than the more complex arrangement of FIG. 8. For example, the logic of FIG. 7 can be implemented in 4 levels of LUTs, while the logic in FIG. 8 can be implemented in 2 levels of LUTs.

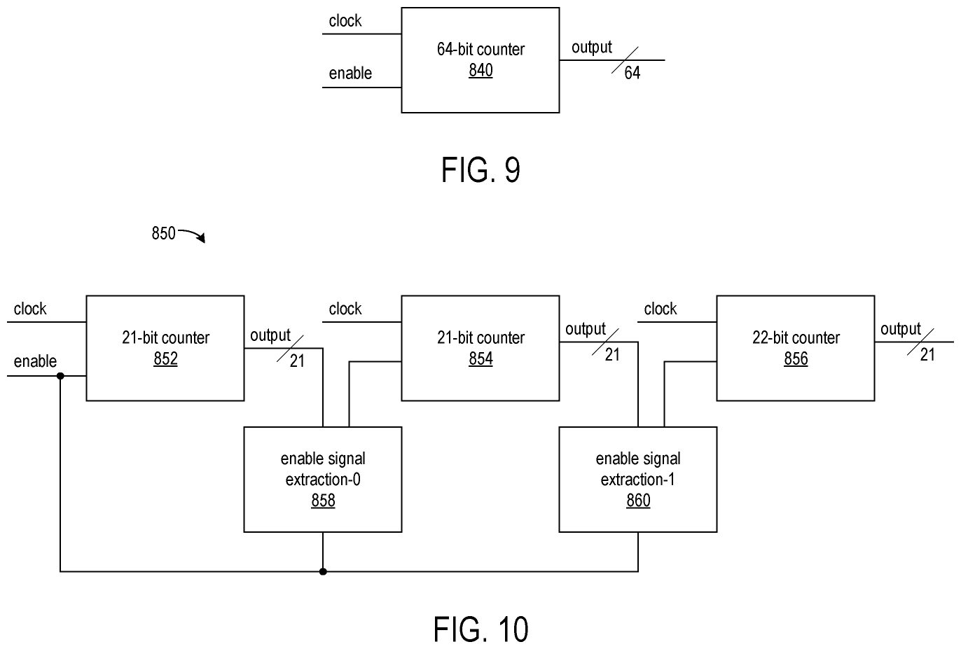

FIG. 9 shows an example of a counter 840 optimized for area, and FIG. 10 shows an alternative counter 850 optimized for timing. Both counters 840 and 850 are exemplary counters that are 64-bit wide. The counter 850 is divided into two counters, each 21 bits wide, and one counter that is 22 bits wide. Each of the three counters outputs a subset of a 64-bit counter value. For example, counter 852 outputs the 21 least significant bits of the 64-bit value, counter 854 outputs 21 middle bits of the 64-bit value, and counter 856 outputs the 22 most significant bits of the 64-bit value.

Enable logic 858 controls incrementing of counter 854, and enable logic 860 controls incrementing of counter 856. In response to counter 852 reaching the maximum 21-bit value, enable logic 858 signals counter 854 to increment. In response to counter 854 reaching the maximum 21-bit value, enable logic 860 signals counter 856 to increment.

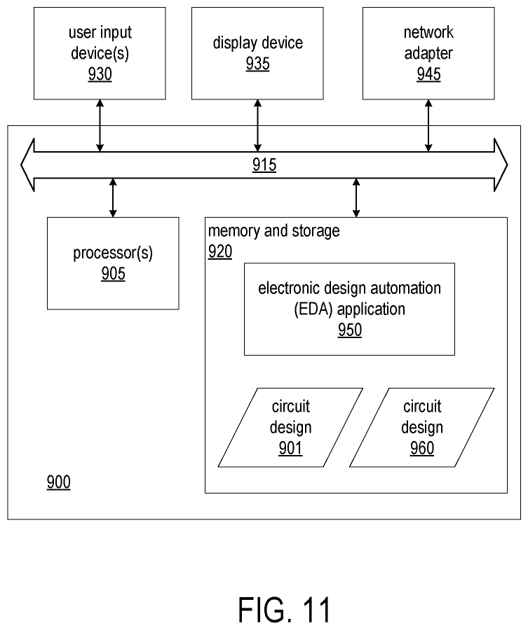

FIG. 11 is a block diagram illustrating an exemplary data processing system (system) 900. System 900 is an example of a system configured to implement an EDA tool. As pictured, system 900 includes at least one processor circuit (or “processor”), e.g., a central processing unit (CPU), 905 coupled to memory and storage arrangement 920 through a system bus 915 or other suitable circuitry. System 900 stores program code and circuit design 901 within memory and storage arrangement 920. Processor 905 executes the program code accessed from the memory and storage arrangement 920 via system bus 915. In one aspect, system 900 is implemented as a computer or other data processing system that is suitable for storing and/or executing program code. It should be appreciated, however, that system 900 can be implemented in the form of any system including a processor and memory that is capable of performing the functions described within this disclosure.

Memory and storage arrangement 920 includes one or more physical memory devices such as, for example, a local memory (not shown) and a persistent storage device (not shown). Local memory refers to random access memory or other non-persistent memory device(s) generally used during actual execution of the program code. Persistent storage can be implemented as a hard disk drive (HDD), a solid state drive (SSD), or other persistent data storage device. System 900 may also include one or more cache memories (not shown) that provide temporary storage of at least some program code and data in order to reduce the number of times program code and data must be retrieved from local memory and persistent storage during execution.

Input/output (I/O) devices such as user input device(s) 930 and a display device 935 may be optionally coupled to system 900. The I/O devices may be coupled to system 900 either directly or through intervening I/O controllers. A network adapter 945 also can be coupled to system 900 in order to couple system 900 to other systems, computer systems, remote printers, and/or remote storage devices through intervening private or public networks. Modems, cable modems, Ethernet cards, and wireless transceivers are examples of different types of network adapter 945 that can be used with system 900.

Memory and storage arrangement 920 may store an EDA application 950. EDA application 950, being implemented in the form of executable program code, is executed by processor(s) 905. As such, EDA application 950 is considered part of system 900. System 900, while executing EDA application 950, receives and operates on circuit design 901. In one aspect, system 900 performs a design flow on circuit design 901, and the design flow can include synthesis, mapping, placement, routing, and the application of the timing budgeting techniques as described herein. System 900 generates an optimized, or modified, version of circuit design 901 as circuit design 960.

EDA application 950, circuit design 901, circuit design 960, and any data items used, generated, and/or operated upon by EDA application 950 are functional data structures that impart functionality when employed as part of system 900 or when such elements, including derivations and/or modifications thereof, are loaded into an IC such as a programmable IC causing implementation and/or configuration of a circuit design within the programmable IC.

Though aspects and features may in some cases be described in individual figures, it will be appreciated that features from one figure can be combined with features of another figure even though the combination is not explicitly shown or explicitly described as a combination.

The methods and system are thought to be applicable to a variety of systems for synthesizing circuit designs. Other aspects and features will be apparent to those skilled in the art from consideration of the specification. The methods and system may be implemented as one or more processors configured to execute software, as an application specific integrated circuit (ASIC), or as a logic on a programmable logic device. It is intended that the specification and drawings be considered as examples only, with a true scope of the invention being indicated by the following claims.

1. A method comprising:
estimating a total delay of a module of a circuit design by an electronic design automation (EDA) tool prior to mapping logic of the module to a target integrated circuit (IC) technology;
determining prior to mapping, whether or not the module is timing critical by the EDA tool based on the total delay of the module and a timing constraint;
restructuring the module for timing optimization by the EDA tool prior to mapping elements of the module to circuit elements of the target IC technology, in response to determining that the module is timing critical;
restructuring the module for area optimization by the EDA tool prior to the mapping, in response to determining that the module is not timing critical;
mapping the elements of the module of the circuit design to the circuit elements of the target IC technology, and placing and routing the circuit elements by the EDA tool;
performing timing optimization on a structure of the module after the mapping in response to determining that the module is timing critical;
performing area optimization on a structure of the module after the mapping in response to determining that the module is not timing critical; and
generating implementation data by the EDA tool after the mapping, placing, and routing for making an IC that implements the circuit design.

2. The method of claim 1, wherein the estimating the total delay includes:
determining respective numbers of logic levels to implement the module of the circuit design;
estimating a delay per logic level for the target IC technology; and
estimating the total delay as a function of the delay per logic level and the respective number of logic levels.

3. The method of claim 2, wherein the estimating the total delay includes:
identifying a data path operator in the module;
looking-up a stored value indicative of an amount of delay of the data path operator implemented on the target IC technology; and
estimating the total delay as the function of the delay of the data path operator.

4. The method of claim 2, wherein:
the target IC technology is a field programmable gate array (FPGA); and
the estimating the delay per logic level includes looking-up a previously estimated delay of a lookup table level of the FPGA.

5. The method of claim 1, further comprising:
tagging a first structure in the module for timing optimization in response to determining that the module is timing critical;
tagging a second structure in the module for area optimization in response to determining that the module is not timing critical;
performing timing optimization on the first structure after the mapping in response to the tagging tagged for timing optimization aftcr the mapping; and
performing area optimization on the second structure after the mapping in response to the tagging tagged for area optimization aftcr the mapping.

6. The method of claim 5, wherein the performing timing optimization includes, in response to the first structure having a first instance of an operator coupled to receive a first operand output from a multiplexer and a second operand from a source other than the multiplexer, and the multiplexer selecting the first operand from two or more alternative operands,
removing the first instance of the operator after the multiplexer, and
creating two or more instances of the operator coupled to receive the two or more alternative operands, respectively, the two or more instances of the operator coupled to receive the second operand and coupled to provide results as inputs to the multiplexer.

7. The method of claim 5, wherein the performing timing optimization includes, in response to the first structure specifying a priority multiplexer having a plurality of alternative inputs and a plurality of selector inputs that control selection of one alternative input of the plurality of alternative inputs:
specifying two or more units of selection logic, including at least a first unit of selection logic and a second unit of selection logic that operate in parallel, wherein
the first unit of selection logic specifies selection of one input of a first subset of the plurality of alternative inputs in response to a first subset of the plurality of selector inputs, and
the second unit of selection logic specifies selection of one input of a second subset of the plurality of alternative inputs in response to a second subset of the plurality of selector inputs; and
specifying final selection logic that controls selection of one output from the two or more units of selection logic in response to a third subset of the plurality of selector inputs.

8. The method of claim 5, wherein the performing timing optimization includes, in response to the first structure specifying one counter having a width of N bits and N being greater than a threshold value, replacing the one counter with two or more counters, wherein widths of the two or more counters sum to N bits, and the two or more counters generate different portions of an N-bit counted value.

9. The method of claim 1, wherein the estimating total delay includes:
identifying a data path operator in the module;
looking-up a stored value indicative of an amount delay of the data path operator; and
estimating the total delay as a function of the delay of the data path operator.

10. The method of claim 1, further comprising making an operable integrated circuit from the implementation data.

11. A system comprising:
one or more processors;
a memory arrangement configured with instructions that when executed by the one or more processors cause the one or more processors to implement an electronic design automation (EDA) tool that performs operations including:
estimating a total delay of a module of a circuit design prior to mapping logic of the module to a target integrated circuit (IC) technology;
determining prior to mapping, whether or not the module is timing critical based on the total delay of the module and a timing constraint;
restructuring the module for timing optimization prior to mapping elements of the module to circuit elements of the target IC technology, in response to determining that the module is timing critical;
restructuring the module for area optimization prior to the mapping, in response to determining that the module is not timing critical;
mapping the elements of the module of the circuit design to the circuit elements of the target IC technology, and placing and routing the circuit elements;
performing timing optimization on a structure of the module after the mapping in response to determining that the module is timing critical;
performing area optimization on a structure of the module after the mapping in response to determining that the module is not timing critical; and
generating implementation data after the mapping, placing, and routing for making an IC that implements the circuit design.

12. The system of claim 11, wherein the instructions for estimating the total delay include instructions that cause the one or more processors to perform operations including:
determining respective numbers of logic levels to implement the module of the circuit design;
estimating a delay per logic level for the target IC technology; and
estimating the total delay as a function of the delay per logic level and the respective number of logic levels.

13. The system of claim 12, wherein the instructions for estimating the total delay include instructions that cause the one or more processors to perform operations including:
identifying a data path operator in the module;
looking-up a stored value indicative of an amount of delay of the data path operator implemented on the target IC technology; and
estimating the total delay as the function of the data path operator.

14. The system of claim 12, wherein:
the target IC technology is a field programmable gate array (FPGA); and
the instructions for estimating the delay per logic level include instructions that cause the one or more processors to look-up a previously estimated delay of a lookup table level of the FPGA.

15. The system of claim 11, wherein the memory arrangement is configured with instructions that when executed by the one or more processors cause the one or more processors to perform operations including:
tagging a first structure in the module for timing optimization in response to determining that the module is timing critical;
tagging a second structure in the module for area optimization in response to determining that the module is not timing critical;
performing timing optimization on the first structure after the mapping in response to the tagging for timing optimization; and
performing area optimization on the second structure after the mapping in response to the tagging for area optimization.

16. The system of claim 15, wherein the instructions for performing timing optimization include instructions that cause the one or more processors, in response to the first structure having a first instance of an operator coupled to receive a first operand output from a multiplexer and a second operand from a source other than the multiplexer, and the multiplexer selecting the first operand from two or more alternative operands, to perform operations including:
removing the first instance of the operator after the multiplexer, and
creating two or more instances of the operator coupled to receive the two or more alternative operands, respectively, the two or more instances of the operator coupled to receive the second operand and coupled to provide results as inputs to the multiplexer.

17. The system of claim 15, wherein the instructions for performing timing optimization include instructions that cause the one or more processors, in response to the first structure specifying a priority multiplexer having a plurality of alternative inputs and a plurality of selector inputs that control selection of one alternative input of the plurality of alternative inputs, to perform operations including:
specifying two or more units of selection logic, including at least a first unit of selection logic and a second unit of selection logic that operate in parallel, wherein
the first unit of selection logic specifies selection of one input of a first subset of the plurality of alternative inputs in response to a first subset of the plurality of selector inputs, and
the second unit of selection logic specifies selection of one input of a second subset of the plurality of alternative inputs in response to a second subset of the plurality of selector inputs; and
specifying final selection logic that controls selection of one output from the two or more units of selection logic in response to a third subset of the plurality of selector inputs.

18. The system of claim 15, wherein the instructions for performing timing optimization include instructions that cause the one or more processors, in response to the first structure specifying one counter having a width of N bits and N being greater than threshold value, to replace the one counter with two or more counters, wherein widths of the two or more counters sum to N bits, and the two or more counters generate different portions of an N-bit counted value.

19. The system of claim 11, wherein the instructions for estimating total delay include instructions that cause the one or more processors to perform operations including:
identifying a data path operator in the module;
looking-up a stored value indicative of an amount delay of the data path operator; and
estimating the total delay as a function of the data path operator.

20. The system of claim 11, wherein the memory arrangement is configured with instructions that when executed by the one or more processors cause the one or more processors to configure a programmable IC to make an operable circuit from the implementation data.
